(19) United States
(12) Patent Application Publication
(10) Pub. No.: US 2013/0020461 A1
(43) Pub. Date: Jan. 24, 2013

(54) REARVIEW MIRROR WITH MONITOR

(71) Applicants: Ayako YAMADA, Fujieda-shi (JP); Masaaki MATSUURA, Fujieda-shi (JP)

(72) Inventors: Ayako YAMADA, Fujieda-shi (JP); Masaaki MATSUURA, Fujieda-shi (JP)

(73) Assignee: MURAKAMI CORPORATION, Shizuoka (JP)

(21) Appl. No.: 13/529,475

(22) Filed: Jun. 21, 2012

(30) Foreign Application Priority Data
Jul. 21, 2011 (JP) 2011-160012

(51) Int. Cl. G01J 1/42

(52) U.S. Cl. 250/200

(57) ABSTRACT

When a reflecting film of a mirror device employed in a rearview mirror with monitor is processed with laser light, a part from which the reflecting film is removed by the laser light transmits light therethrough, while the remaining part reflects the light. Therefore, the light transmittance can be changed easily according to the area irradiated with the laser light. Further, when laser-processing a reflecting/transmitting mirror region corresponding to a monitor screen, cells having the same form are arranged in a matrix, and each cell is formed with an irregular pattern by the laser light.

### CROSS-REFERENCE TO RELATED APPLICATIONS

This application claims priority to Japanese Patent Application No. 2011-160012 filed on Jul. 21, 2011, the entire contents of which are incorporated by reference herein.

### BACKGROUND OF THE INVENTION

1. Field of the Invention

The present invention relates to a rearview mirror with monitor, in which a monitor is provided on the rear side of a reflecting/transmitting mirror region of a mirror device having a transparent substrate made of glass or the like and a reflecting film disposed on the rear face of the transparent substrate.

2. Related Background Art

Japanese Patent Application Laid-Open No. 2009-126223 has conventionally been known as a technique in such a field. The mirror device of the rearview mirror with monitor disclosed in this publication has a semitransparent reflecting film formed on the rear face of a glass substrate in order to improve reflection and transmission characteristics. This—semitransparent reflecting film is a dielectric multilayer film in which three layers constituted by a high refractive index material film, a low refractive index material film, and a high refractive index material film are stacked sequentially on the rear face of the glass substrate. A dark mask member constituted by a resin sheet, a resin film, a paint, or the like is provided on the rear face of the dielectric multilayer film. In the mirror device, the mask member is formed with an opening in a region where the monitor is placed. Therefore, the monitor can be seen through the dielectric multilayer film in the opening region when the monitor is turned on, while the dielectric multilayer film enables this region to function as a mirror when the monitor is turned off.

### SUMMARY OF THE INVENTION

### Technical Problem

However, as mentioned above, the dielectric multilayer film is formed over the whole rear face of the glass substrate in the mirror device, while necessitating the mask member in order for the dielectric multilayer film to function as a reflecting film and making it necessary to form the mask member with an opening for the monitor, which makes the forming of the dielectric multilayer film itself cumbersome and complicates its structure, whereby the reflecting/transmitting mirror region is hard to form inexpensively and simply.

It is an object of the present invention to provide a rearview mirror with monitor, which can form a reflecting/transmitting mirror region inexpensively and simply in a mirror device.

### Solution to Problem

The rearview mirror with monitor in accordance with the present invention comprises a mirror device having a transparent substrate and a reflecting film disposed on a rear face of the transparent substrate and including a reflecting/transmitting mirror region for partly transmitting light therethrough, a monitor disposed on the rear face side of the mirror region of the reflecting/transmitting mirror device, and a housing for accommodating the monitor; wherein the reflecting/transmitting mirror region is formed by irradiating the reflecting film with laser light, the reflecting/transmitting mirror region including a plurality of cells having the same form arranged in a matrix, each of the cells having an irregular pattern formed by irradiation with the laser light.

When the reflecting film of the mirror device employed in this rearview mirror with monitor is laser-processed, a part from which the reflecting film is removed by laser light transmits light therethrough, while the remaining part reflects the light. Therefore, the light transmittance can be changed easily according to the area irradiated with the laser light. Also, since dielectric multilayer films which have been used conventionally are unnecessary, the reflecting/transmitting mirror region can be formed inexpensively and easily in the mirror device. When the reflecting film is formed with a simple dot or lattice pattern in the reflecting/transmitting mirror region by laser light, glare and moirés are likely to occur because of arrangements (e.g., stripe, delta, and mosaic arrangements) of RGB in pixels, thereby making the monitor screen harder to see. Therefore, in view of the fact that pixels constructed by RGB are arranged in a matrix in the screen of the monitor provided with the rearview mirror, cells having the same form are arranged in a matrix, while each cell is formed with an irregular pattern by the laser light. Such a contrivance makes it hard for glare and moirés to occur on the monitor screen even when cells having the same form are arranged in a matrix in the reflecting/transmitting mirror region. Also, since the cells having irregular patterns are arranged regularly in a matrix in the reflecting/transmitting mirror region, it will be sufficient if a laser light scanning pattern for the cells is determined and regularly repeated. This can easily make it hard for glare and moirés to occur on the monitor screen regardless of arrangements (e.g., stripe, delta, and mosaic arrangements) of RGB in pixels without complicating the laser light scanning program.

Each cell may have a light-transmitting part for transmitting light therethrough and a light-blocking part for reflecting the light, while the light-transmitting or light-blocking part may be dotted irregularly in each cell.

When the light-transmitting or light-blocking part is formed like a line, the reflection/transmission ratio is hard to set at the time of designing. When the light-transmitting or light-blocking part is dotted, by contrast, the total area ratio between the light-transmitting and light-blocking parts is easy to specify at the time of designing, so that the total area ratio of the light-transmitting part (light-blocking part) in the whole cell area gives the light reflectance (light transmittance), thus facilitating the calculation thereof, whereby the design of reflection/transmission ratio can be changed easily.

Each cell may have a rectangular form, and a plurality of light-blocking parts may be dotted irregularly so as to disperse while having such a relationship in arrangement as to form no gap therebetween on each side of each cell when projected thereon.

Each cell may have a rectangular form, and a plurality of light-transmitting parts may be dotted irregularly so as to disperse while having such a relationship in arrangement as to form no gap therebetween on each side of each cell when projected thereon.

Each light-transmitting part or light-blocking part may have a rectangular form.

Employing such a structure makes it very easy to calculate the reflection/transmission ratio.

Each light-transmitting part may be formed by irradiation with the laser light.

### BRIEF DESCRIPTION OF THE DRAWINGS

FIG. 1(a) is a front view illustrating an embodiment of the rearview mirror with monitor in accordance with the present invention, while FIG. 1(b) is a sectional view taken along the line A-A of FIG. 1(a);

FIG. 2(a) is a diagram illustrating a cell arrangement in a reflecting/transmitting mirror region, while FIG. 2(b) is a diagram illustrating one cell; and

FIG. 3(a) is a diagram illustrating a cell in accordance with a modified example, while FIG. 3(b) is a diagram illustrating a cell in accordance with another modified example.

### DESCRIPTION OF THE PREFERRED EMBODIMENTS

In the following, preferred embodiments of the rear mirror with monitor in accordance with the present invention will be explained in detail with reference to the drawings.

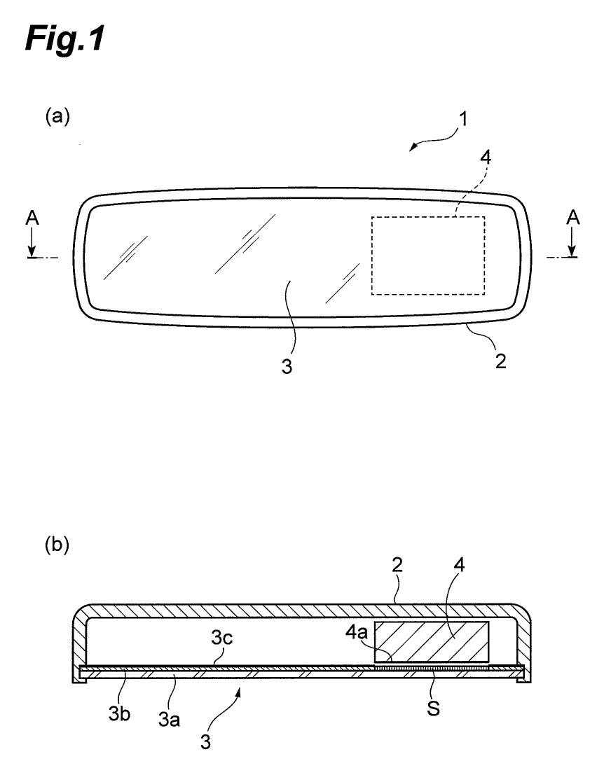

As illustrated in FIG. 1, an inner mirror 1, which is an example of rearview mirrors, has a mirror device 3 secured to the opening side of a housing 2, while a liquid crystal monitor 4 is accommodated in the housing 2. In the mirror device 3, a region facing a screen 4a of the monitor 4 serves as a reflecting/transmitting mirror region S. The reflecting/transmitting mirror region S partly transmits light therethrough.

The mirror device 3 comprises a transparent substrate 3a made of a transparent glass or resin material, a reflecting film 3b constructed by forming a silver film on the rear face of the transparent substrate 3a, and a mask 3c for preventing the reflecting film 3b from being corroded and damaged. The reflecting/transmitting mirror region S of the mirror device 3 is processed with laser light. The laser light can be made incident on the mirror device 3 from the transmission substrate 3a side, so as to remove the reflecting film 3b and the mask 3c. The reflecting film 3b can be formed by vapor deposition, silvering, vacuum plating, or the like, while aluminum may be used in place of silver.

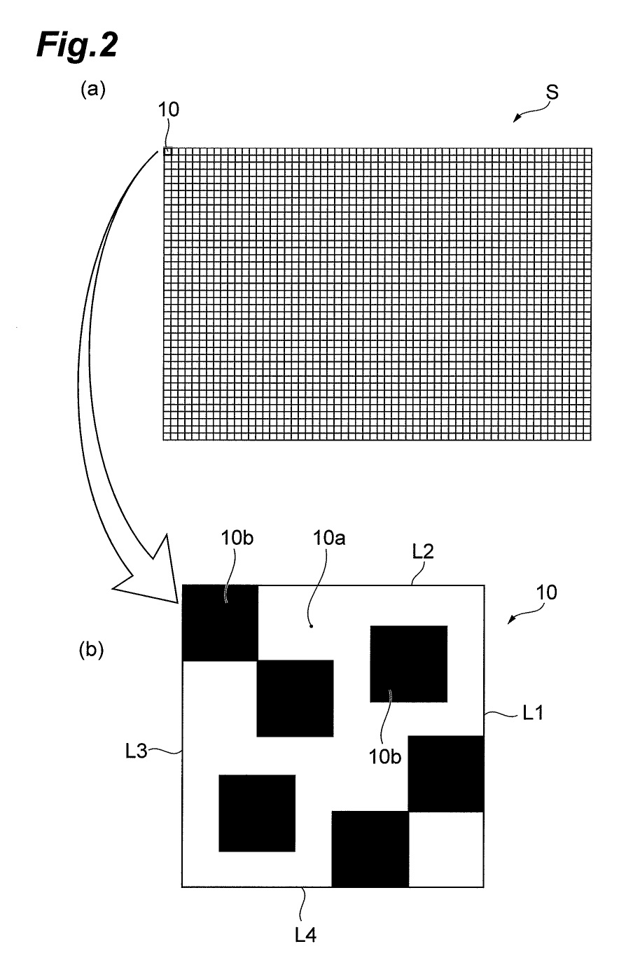

As illustrated in FIG. 2, cells 10 formed with predetermined patterns are arranged in a matrix over the whole surface of the reflecting/transmitting mirror region S, while the laser light shapes the cells 10 into the same form. The laser light forms each cell 10 with an irregular pattern. Each cell 10 is a square each side of which is 0.79 mm in length. In this case, the pixel arrangement pitch in the monitor 4 is about 0.3 mm.

The cell 10 has a light-transmitting part 10a for transmitting light therethrough and light-blocking parts 10b for reflecting the light. A plurality of light-blocking parts 10b having the same form constituted by a square are dotted irregularly in the cell 10. The light-transmitting part 10a is formed by irradiation with the laser light. When forming the light-transmitting part 10a, the light-blocking parts 10b are not irradiated with the laser light. The plurality of light-blocking parts 10b are dotted irregularly so as to disperse while having such a relationship in arrangement as to form no gap therebetween on each of sides L1 to L4 of the cell 10 when projected thereon.

When the reflecting film 3b and mask 3c of the mirror device 3 employed in the inner mirror 1 with monitor are laser-processed at the same time, a part from which the reflecting film 3b and mask 3c are removed by the laser light transmits light therethrough, while the remaining part reflects the light. Therefore, the light transmittance can be changed easily according to the laser light irradiation area. Also, since dielectric multilayer films which have been used conventionally are unnecessary, the reflecting/transmitting mirror region S can be formed inexpensively and easily in the mirror device 3.

When the reflecting film 3b is formed with a simple dot or lattice pattern by laser light in the reflecting/transmitting mirror region S, glare and moirés are likely to occur because of arrangements (e.g., stripe, delta, and mosaic arrangements) of RGB in pixels, thereby making the screen 4a of the monitor 4 harder to see. Therefore, in view of the fact that pixels constructed by RGB are arranged in a matrix in the screen 4a of the monitor 4 provided with the inner mirror 1, cells having the same form are arranged in a matrix, while each cell 10 is formed with an irregular pattern by the laser light.

Such a contrivance makes it hard for glare and moirés to occur on the screen 4a of the monitor 4 even when the cells 10 having the same form are arranged in a matrix in the reflecting/transmitting mirror region S. Also, since the cells having irregular patterns are arranged regularly in a matrix in the reflecting/transmitting mirror region S, it will be sufficient if a laser light scanning pattern for the cells 10 is determined and regularly repeated. This can easily make it hard for glare and moirés to occur on the screen 4a of the monitor 4 regardless of arrangements (e.g., stripe, delta, and mosaic arrangements) of RGB in pixels without complicating the laser light scanning program.

When the light-transmitting or light-blocking part is formed like a line, the reflection/transmission ratio is hard to set at the time of designing. By contrast, dotting the light-blocking parts 10b makes it easy to specify the total area ratio between the light-transmitting part 10a and the light-blocking parts 10b at the time of designing, so that the total area ratio of the light-blocking parts 10b in the whole cell area gives the light reflectance, thus facilitating the calculation thereof, whereby the design of reflection/transmission ratio can be changed easily. Shaping the light-blocking parts 10b into the same rectangular (oblong or square) form makes it very easy to calculate the reflection/transmission ratio.

The present invention is not limited to the above-mentioned embodiment as a matter of course.

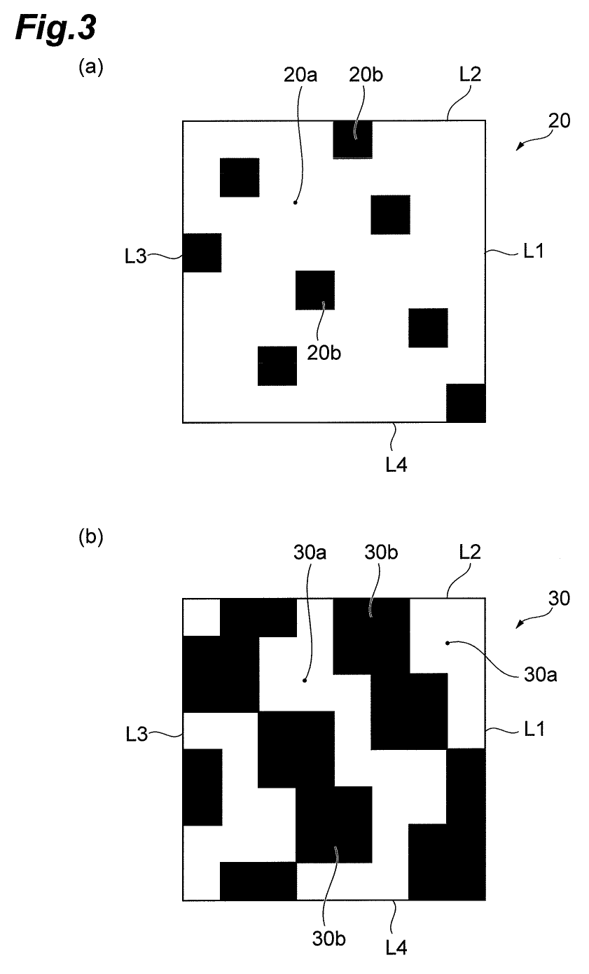

In a modified embodiment illustrated in FIG. 3(a), a cell 20 has a light-transmitting part 20a formed by irradiation with laser light and light-blocking parts 20b not irradiated with the laser light, while light-blocking parts 20b having the same small square form are dotted irregularly in the cell 20. In the cell 20 in this case, as in the cell 10 of FIG. 2, all of the square light-blocking parts 20b are dotted irregularly so as to disperse while having such a relationship in arrangement as to form no gap therebetween on each of sides L1 to L4 of the cell 20 when projected thereon.

In another modified embodiment illustrated in FIG. 3(b), a cell 30 has a light-transmitting part 30a formed by irradiation with laser light and light-blocking parts 30b not irradiated with the laser light, while light-blocking parts 30b formed by joining rectangular blocks having sizes different from each other or those having the same size together are dotted irregularly in the cell 30. In the cell 30 in this case, as in the cell 10 of FIG. 2, all the light-blocking parts 30b are dotted irregularly so as to disperse while having such a relationship in arrangement as to form no gap therebetween on each of sides L1 to L4 of the cell 30 when projected thereon.

Though the light-blocking parts 10b, 20b, 30b are painted black in FIGS. 2 and 3, the black-painted parts may serve as the light-transmitting parts 10a, 20a, 30a.

The mirror device 3 employed in the present invention may lack the mask 3c.

The rearview mirror in accordance with the present invention may be a side mirror.

What is claimed is:

1. A rearview mirror with monitor comprising:
a mirror device having a transparent substrate and a reflecting film disposed on a rear face of the transparent substrate and including a reflecting/transmitting mirror region for partly transmitting light therethrough;
a monitor disposed on the rear face side of the reflecting/transmitting mirror region of the mirror device; and
a housing for accommodating the monitor;
wherein the reflecting/transmitting mirror region is formed by irradiating the reflecting film with laser light, the reflecting/transmitting mirror region including a plurality of cells having the same form arranged in a matrix, each of the cells having an irregular pattern formed by irradiation with the laser light.

2. A rearview mirror with monitor according to claim 1, wherein each of the cells has a light-transmitting part for transmitting light therethrough and a light-blocking part for reflecting the light, the light-transmitting or light-blocking part being dotted irregularly in each of the cells.

3. A rearview mirror with monitor according to claim 2, wherein each of the cells has a rectangular form; and
wherein a plurality of the light-blocking parts are dotted irregularly so as to disperse while having such a relationship in arrangement as to form no gap therebetween on each side of each of the cells when projected thereon.

4. A rearview mirror with monitor according to claim 2, wherein each of the cells has a rectangular form; and
wherein a plurality of the light-transmitting parts are dotted irregularly so as to disperse while having such a relationship in arrangement as to form no gap therebetween on each side of each of the cells when projected thereon.

5. A rearview mirror with monitor according to claim 2, wherein each of the light-transmitting or light-blocking parts has a rectangular form.

6. A rearview mirror with monitor according to claim 2, wherein each of the light-transmitting parts is formed by irradiation with the laser light.
